(19) United States
(12) Patent Application Publication
(10) Pub. No.: US 2022/0071076 A1
(43) Pub. Date: Mar. 10, 2022

(54) SYSTEM AND METHOD FOR CONNECTING TINES TO A ROTOR OF A TILLING MACHINE

(71) Applicant: F.P. Bourgault Tillage Tools Ltd., St. Brieux (CA)

(72) Inventors: JORDAN MICHAEL SOULIER, St. Brieux (CA); KELVIN JOHN STEVENSON, St. Brieux (CA)

(21) Appl. No.: 17/466,514

(22) Filed: Sep. 3, 2021

Related U.S. Application Data
(60) Provisional application No. 63/074,780, filed on Sep. 4, 2020.

(51) Int. Cl. A01B 33/14; A01B 33/02

(52) U.S. Cl. CPC A01B 33/142; A01B 33/021

(57) ABSTRACT

A system for connecting tines to a rotor of a tilling machine is disclosed. The system includes an adaptor for mounting to the rotor, a tine for coupling to the adaptor by insertion into the aperture, and a locking element movably coupled to one of the adaptor and the tine, the locking element movable into a locking position to engage the other of the adaptor and the tine when in the coupling position to resist removal of the tine from the coupling position. A corresponding method is also disclosed. A tine for connecting to a rotor of a tilling machine is also disclosed.

### CROSS REFERENCE TO RELATED APPLICATIONS

This application claims the benefit of U.S. Provisional Patent Application No. 63/074,780 entitled “SYSTEM AND METHOD FOR CONNECTING TINES TO A ROTOR OF A TILLING MACHINE” filed Sep. 4, 2020, the entire contents of which are incorporated herein by reference.

### FIELD

This application relates generally to a system and method for connecting tines to a rotor of a tilling machine.

### BACKGROUND

In some known tilling machines, tilling tines are mounted to a rotor with a couple of bolts extending parallel to the axis of rotation of the rotor such that the tines extend from a circumference of the rotor in a generally radial direction. As the tines wear, they require replacement. Accessing the mounting bolts may be difficult or time consuming due to the spacing and clearance between multiple rotors arranged in parallel and/or due to wear and dirt buildup on the bolts and nuts.

Accordingly, there is a desire to allow for faster and easier mounting and dismounting of tines to the rotor.

### SUMMARY

According to one aspect of the present disclosure, there is provided a system for connecting tines to a rotor of a tilling machine, the system comprising: an adaptor for mounting to the rotor, the adaptor comprising first and second adaptor coupling portions defining an aperture therebetween; a tine for coupling to the adaptor by insertion into the aperture, the tine comprising first and second tine coupling portions shaped complementary to the first and second adaptor coupling portions, respectively, the tine being positionable in the aperture in a coupling position, the first and second tine coupling portions mating with the first and second adaptor coupling portions, respectively, in the coupling position; and a locking element movably coupled to one of the adaptor and the tine, the locking element movable into a locking position to engage the other of the adaptor and the tine when in the coupling position to resist removal of the tine from the coupling position.

According to another aspect of the present disclosure, there is provided a method of connecting a tine to a rotor of a tilling machine, the method comprising: mounting an adaptor to the rotor, the adaptor defining an aperture between the adaptor and the rotor; positioning the tine in the aperture in a coupling position in which the tine mates with the adaptor; and moving a locking element into a locking position in which it resists the tine from being extracted from the coupling position.

According to another aspect of the present disclosure, there is provided a tine for connecting to a rotor of a tilling machine, the tine comprising: a coupling part, the coupling part having first and second tine coupling portions spaced from each other, each of first and second tine coupling portions comprising a recess shaped to receive a complementary portion of an adaptor mounted to the tine; and a working part extending from the coupling part.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 shows a prior art rotor and tine configuration.

FIG. 2 shows a rotor with a system according to embodiments of the present disclosure mounted thereto.

FIG. 3 shows an adaptor of a system according to embodiments of the present disclosure.

FIG. 4 is a first plan view of the adaptor of FIG. 3.

FIG. 5 is a second plan view of the adaptor of FIG. 3.

FIG. 6 is a front view of the adaptor of FIG. 3.

FIG. 7 shows a tine coupled to an adaptor according to embodiments of the present disclosure.

FIG. 8 shows a bolt for locking the tine to the adaptor according to embodiments of the present disclosure.

FIG. 9 shows a method according to embodiments of the present disclosure.

FIGS. 10 shows another embodiment of a system for connecting tines to a rotor according to the present disclosure.

FIG. 11 shows a partial rear view of the system of FIG. 10.

FIG. 12A shows the system of FIG. 10 with the tine in an uncoupled position.

FIG. 12B shows an enlarged view of a portion of FIG. 12A.

FIG. 13 shows the system of FIG. 10 with the tine in an uncoupled position.

FIG. 14 shows the system of FIG. 10 with the tine in a coupling position.

FIG. 15 shows the system of FIG. 10 with a tool used to release the tine from the coupling position.

FIG. 16 shows the system of FIG. 10 with the tine returned to an uncoupled position.

### DETAILED DESCRIPTION

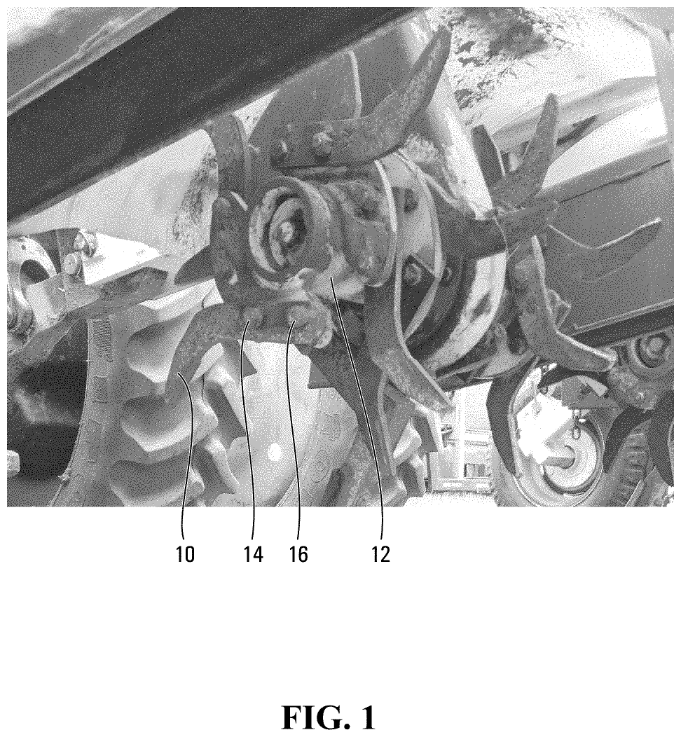

FIG. 1 shows a prior art configuration of tines 10 connected to a rotor 12 of a tilling machine. Each tine 10 is mounted to the rotor 12 using two bolts 14, 16 that extend through holes in the tine 10. The tine 10 has a generally flat body and is arranged to extend radially from the rotor 12 when fixed thereto. Multiple tines 10 are arranged around the circumference of the rotor 12 to till the ground in operation.

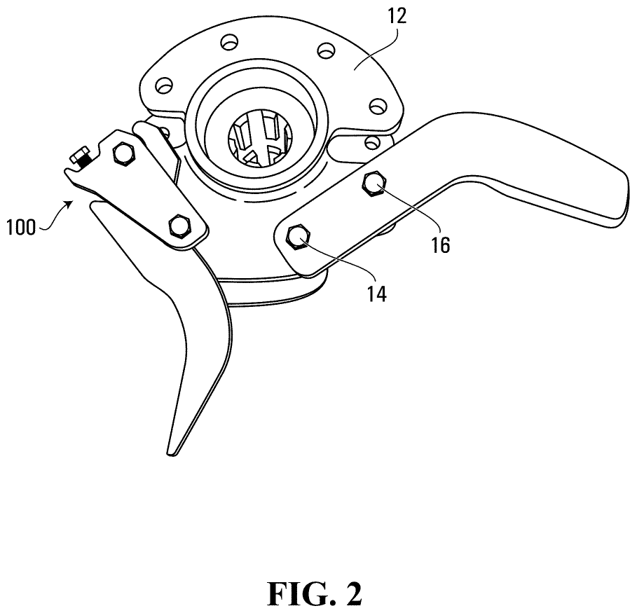

FIG. 2 shows the rotor 12 in isolation with two tines mounted to the rotor. One of the tines is mounted according to the prior art by being mounted directly to the rotor 12 using bolts 14, 16. The other tine is mounted to the rotor 12 according to an embodiment of the connection system 100 according to the present disclosure.

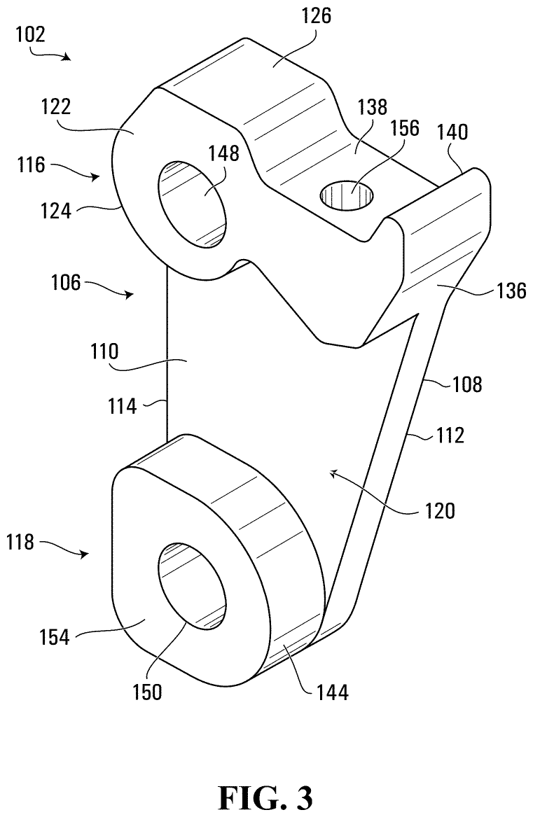

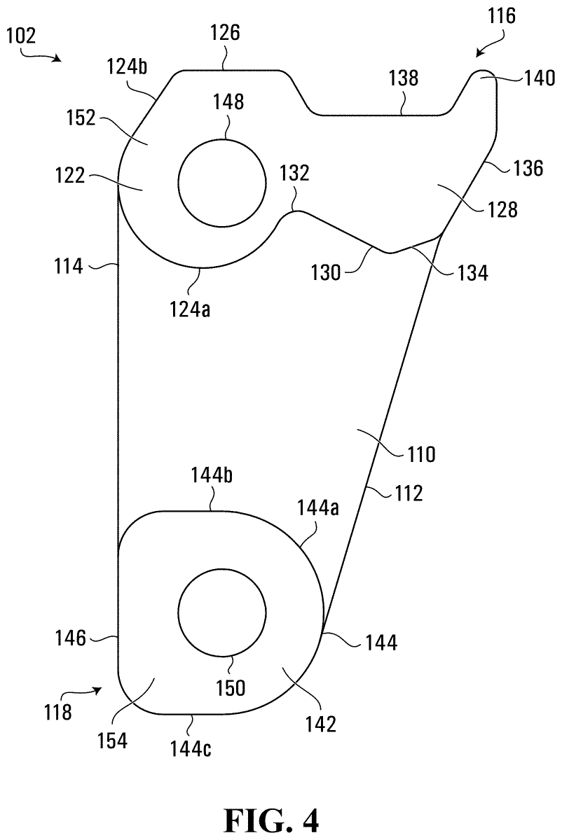

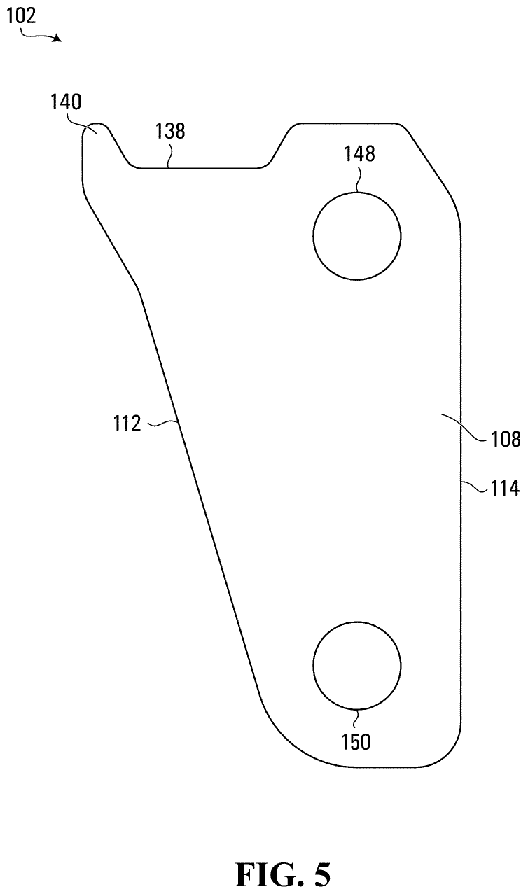

Referring to FIGS. 3 to 6, one embodiment of a system 100 according to the present disclosure will be described. In the illustrated embodiment, an adaptor 102 comprises a body 106 having a generally flat top side 108, a generally flat underside 110, a flat front side 112 and a flat rear side 114. First and second adaptor coupling portions 116 and 118, respectively, project from the under side 110 at opposite ends of the body 106, respectively, defining a gap or aperture 120 therebetween. The front side 112 is angled obliquely with respect to the rear side 114 such that the body 106 generally narrows from the first coupling portion 116 to the second coupling portion 118.

The first coupling portion 116 includes a first stop portion 122 positioned or arranged adjacent the rear side 114. The first stop portion 122 defines a shaped first stop surface 124 that includes a curved stop surface portion 124a that generally faces towards the aperture 120 and a flat, generally angled stop surface portion 124b that merges with the surface portion 124a. The surface portion 124b is angled away from the rear side 114 and extends to a top surface 126 of the first coupling portion 116, the top surface 126 extending generally perpendicular to the rear side 114.

The first coupling portion 116 further includes a locking portion 128 that is integral with the first stop portion 122 and arranged adjacent thereto extending from the first stop portion 122 to the front side 112. The locking portion 128 defines a flat, angled lower surface 130 generally facing toward the aperture 120, the lower surface 130 merging with the curved stop surface portion 124a at an interior curvature 132. The locking portion 128 further defines flat front surfaces 134 and 136 that meet each other at an angle and form a front part of the locking portion 128. Moreover, the locking portion 128 defines a top surface 138 recessed with respect to the top surface 126 that is adjacent to the top surface 138 towards a rear of the adaptor 102. On another side of the top surface 138, towards the front of the adaptor 102, a lip 140 projects upward from the locking portion 128, such that the top surface is recessed with respect to both the top surface 126 and the lip 140.

The second coupling portion 118 is positioned or arranged opposite the first coupling portion 116 at a bottom of the adaptor 102 and extends from the rear side 114 to the front side 112. The second coupling portion 118 includes a second stop portion 142. The second stop portion 142 defines a second stop surface 144 having a generally curved, circular stop surface portion 144a facing away from the rear side 114 that merges with generally flat upper and lower stop surface portions 144b and 144c, respectively, which are arranged generally perpendicular to the rear side 114. Moreover, the second coupling portion 118 defines a rear surface 146 that is generally co-planar to the rear side 114.

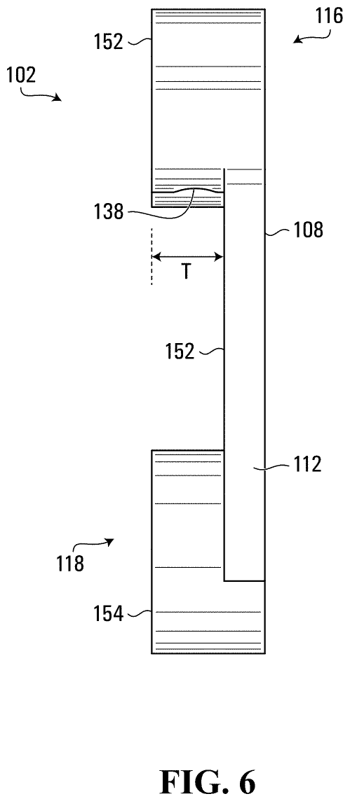

The first and second coupling portions 116, 118 define through bores 148 and 150, respectively, which are spaced apart such that they match the spacing of corresponding holes on the rotor 12, permitting the adaptor 102 to be mounted to the rotor 12, for example using bolts 14, 16. Moreover the first and second coupling portions 116, 118, comprise generally flat, co-planar under sides 152, 154, respectively, that are parallel to the under side 110 and contact the rotor 12 when the adaptor 102 is mounted thereto. Once mounted, the rotor thus forms a second wall to the aperture 120 opposite the underside 110. As best seen in FIG. 6, the height of the first and second coupling portion 116, 118 with respect to the underside 110 therefore also define a thickness T of the aperture 120 when the adaptor 100 is mounted to the rotor 12.

The locking portion 128 includes a through bore 156 intended to receive a locking element 158, which is configured as a set screw bolt in the illustrated embodiment, to lock a tine into place, as discuss further below.

Other embodiments are also possible. For example, the overall shape and configuration of the adaptor and body may be different and configured differently to accommodate a different spacing or different configuration of a rotor to which the adaptor is mounted. Accordingly, the shape, positioning, spacing, dimensions and configuration of the first and second adaptor coupling portions may be different than in the illustrated embodiment. For example, the first stop portion and locking portion may not be integral with each other and could be separate. The stop portions may have different curvatures or no curvatures at all and instead be configured with one or more facetted stop surfaces. The placement, sizing and spacing of the bores for mounting the adaptor may be different to accommodate different openings on the rotor or the bores may not be present at all and the adaptor mounted to the rotor in a different manner known to the skilled person in the art. The relative positioning of the first and second stop surfaces may be different than shown.

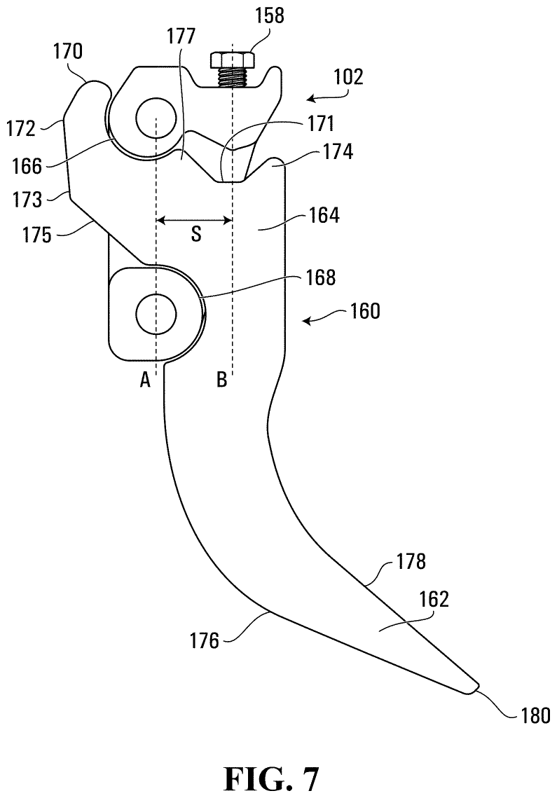

Referring to FIG. 7, a tine 160 for use with the adaptor 102 as part of the system 100 is shown coupled to the adaptor 102. The adaptor 102 is not shown as mounted to the rotor 12, so as to ease description of the tine 160.

In the illustrated embodiment, the tine 160 includes a working part 162, forming one end of the tine 160 opposite a coupling part 164. The coupling part 164 includes first and second tine coupling portions, respectively. In the illustrated embodiment, the first and second tine coupling portions are configured as recesses 166 and 168, which are shaped complementary to and receive at least part of the first and second stop surfaces 124, 144, respectively. In particular, the coupling part 164 includes an arm-like extension 170 that, when the tine 160 is in a coupling position within the adaptor 102, extends rearwards past the rear side 114 and at least part of the way around or along the first stop portion 122, contacting the stop surface portions 124a and 124b. The extension 170 includes a rear side 172 that includes a generally, flat rear surface 173 that is generally parallel to the flat rear side 114 of the adaptor 102 and a generally flat surface 175 that is angled with respect to the rear surface 173 and extends from the rear surface 173 to the second recess 168.

The coupling part 164 further includes a locking surface 171 that, when the tine 160 is in the coupling position, is spaced from and does not contact surfaces 130 and 134 of the locking portion 128 of the adaptor 102. The locking surface 171 is recessed and arranged between two opposing extensions 177 and 174. The extension 177 merges with the contour of the first recess 166 and extends towards the interior curvature 132. The extension 174 extends forwards beyond the front edge 112 and upwards generally mimicking the progression of surfaces 134 and 136 of the locking portion 128.

The working part 162 includes leeward and windward surfaces 176, 178 that are curved and result in a narrowing shape, meeting at leading edge 180.

Other embodiments are also possible. The shape, positioning and configuration of the tine may differ as the corresponding features of the adaptor are altered in order to ensure mating and coupling of the tine to the adaptor. In some embodiments, the first and second stop portions on the adaptor may be configured as recesses and the corresponding first and second tine coupling portions may be configured as projections. The relative positioning of the first and second tine coupling portions may differ to accommodate a different configuration of the first and second adaptor coupling portions as shown. The configuration of the locking element may also differ. The set bolt may contact a different portion of the tine than shown. There may be multiple locking elements. The locking element may also be configured differently and not as a set bolt, for example as a spring loaded clamp, hook or catch that engages a corresponding feature of the tine.

To mount the tine 160 to the rotor 12 after the adaptor 102 is mounted to the rotor 12, as described above, the tine 160 is inserted into the aperture 120 from the front until the extension 170 clears the rear side 114 and the first stop portion 140. The tine 160 is then rotated into the coupling position such that the first and second recesses 166, 168 receive and contact the first and second stop portions 122, 142, respectively. To lock the tine 160 into place, screw bolt 158 is advanced until it contacts the locking surface 171 in a locking position and is then tightened as desired. In the locking position, the tine 160 is prevented from being removed rearward or frontward due to interference with the adaptor 102, such as the first and second stop portions 122, 142 and the locking bolt 158. Moreover, the thickness of the tine 160 generally matches that of the aperture 120 such that the tine 160 is held relatively firmly in place between the rotor 12 on the one side and the underside 110 on the other side.

In the mounted position, the working part 162 would generally extend radially from the rotor 12 for use in the tiller machine. Following wear of the working part 162 or possibly for other reasons, a user may wish to replace the tine 160. To do so, the bolt 158 is loosened and sufficiently retracted to allow the tine to be rotated and disengaged from the first and second stop portions 122, 142 and removed. In such a manner, the adaptor 100 and corresponding coupling part 168 of the tine 160 allow for relatively quick connection and disconnection of a tine as compared to the prior art manner of mounting tines directly to the rotor 12.

It will be noted that aspects of the tine 160 facilitate insertion and extraction of the tine 160 into and from the adaptor 102. For example, the extension 170 is sized and configured to extend through the gap between the first and second stop portions 122, 142 and with sufficient clearance to provide room for a rotation of the tine 160 to engage the first and second stop portions 122, 142. This may be in part due to the angled rear surface 175, which allows for a narrower form factor and for additional clearance of the extension 170 with respect to the second stop portion 142. Moreover, the spacing between the locking surface 171 and the surfaces 130 and 134 is configured to allow for rotation of the tine 160 during extraction, while not being so large that the bolt 158 would be unduly exposed when locking the tine into position.

Moreover, the adaptor 102 and tine 160 are configured to aid in ensuring secure mounting of the tine 160. For example, a spacing S between the line A running through the centre of bore 148 and an axis B extending through the bore 156 result in a moment being created when the bolt 158 contacts the tine 160, thereby further urging the tine 160 against the respective first and second stop portions 122, 142. Similarly, the working part 162 is configured with respect to the coupling part 164 such that forces exerted on the working part 162 during use create a further moment and urge the tine 160 against the first and second stop portions 122, 142.

In addition, both the lip 140 and the extension 174 aid in protecting and shielding the bolt 158 from wear, dirt and debris during use. Specifically, in the locking position, the head of the bolt 158 is positioned within the recess behind the lip 140. Similarly, the extension 174 extends up and protects portion of the bolt 158 extending across the gap and contacting the tine 160.

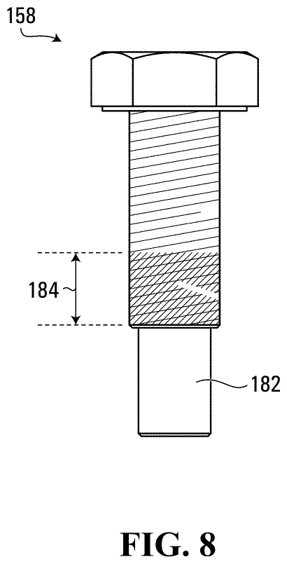

Referring to FIG. 8, in some embodiments the bolt 158 may have a lower portion 182 without threads. This prevents exposed threads on the bolt from being damaged during use (e.g. due to debris or dirt) and thereafter damaging the internal threads of the bore 156 when the bolt 158 is loosened to replace the tine 160. In some embodiments, the bolt 158 may also have a portion 184 of the thread be pre-coated with a thread locker to reduce the need for a jamb nut and hold the bolt 158 in place during use, where it may be exposed to debris and vibration resulting in loosening of the bolt.

Other embodiments are possible. In some embodiments, the locking element may be configured differently and/or be connected to the tine for movement and engagement with the adaptor.

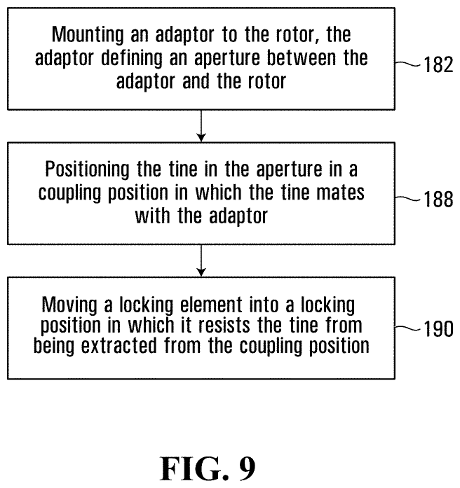

While the embodiments of a system according to the present disclosure have been described so far, all methods related to the system are also within the present disclosure. Thus, referring to FIG. 9, the present disclosure also relates to a method of mounting a tine to a rotor of a tilling machine. At 186, the method includes mounting an adaptor to the rotor, the adaptor defining an aperture between the adaptor and the rotor. At 188, the tine is positioned in the aperture in a coupling position in which the tine mates with the adaptor. At 190, a locking element is moved into a locking position in which it resists the tine from being extracted from the coupling position.

Mounting the adaptor to the rotor comprises may include connecting the adaptor to the rotor at two connection points spaced from each other. For example, in some embodiments, this may include mounting the adaptor 102 to the rotor 12 using bolts passing through bores 148 and 150.

Positioning the tine may include positioning the tine such that the tine is substantially parallel to a face of the rotor, the face being perpendicular to an axis of rotation of the rotor. Moreover, positioning the tine in the coupling position may include inserting the tine in the aperture until the tine clears at least one adaptor coupling portion and rotating the tine into the coupling position to mate with the at least one adaptor coupling portion. For example, in some embodiments, this may include inserting the tine, such as the tine 160, until the extension 170 clears the first and second coupling portions 116 and 118 and rotating the tine 160 to coupling thereto.

Rotating the tine into the coupling position may include rotating the tine into the coupling position to mate with first and second adaptor coupling portions spaced from each other. For example, in some embodiments, this may include rotating the tine 160 into the coupling position such that first and second recesses 166 and 168 mate with first and second coupling portions 116 and 118, respectively.

Moving the locking element to engage the tine may include applying a force on the tine to urge the tine further into the coupling position. In some embodiments, the locking element is a set bolt and moving the locking element comprises advancing the set bolt. For example, in some embodiments, the bolt 158 is advanced and applies a force against the surface 171 to urge the tine 160 against the first and second coupling portions 116, 118.

While a single system comprising an adaptor and tine have been described, it will be appreciated that a plurality of systems may be mounted onto a single rotor of a tilling machine, such as the rotor 12 of FIG. 1. Moreover, in some embodiments, to accommodate opposite sides of a rotor, left- and right-facing adaptors may be needed. Left- and right-facing adaptors may be identical, but mirror images of each other. Tines according to the present disclosure, if symmetrical about their sagittal plane, such as tine 160 described above, could be used in both left- and right-facing adaptors.

The adaptor and tine may be manufactured and produced according to a variety of methods known to those skilled in the art, which may include, without limitation, moulding, forging, stamping, machining, welding, etc. Similarly, the adaptor and tine may be made of one or more materials known to those skilled in the art such as a variety of metals, including, without limitation, hardened metals and alloys. Different portions of the adaptor or tine may be made of multiple materials attached to each, for example by welding.

It will also be understood that even though the adaptor and tine of the illustrated embodiment are described each as a unitary piece, each of the adaptor and tine may be produced from multiple components fixed to each other, for example by welding or mechanical fastening.

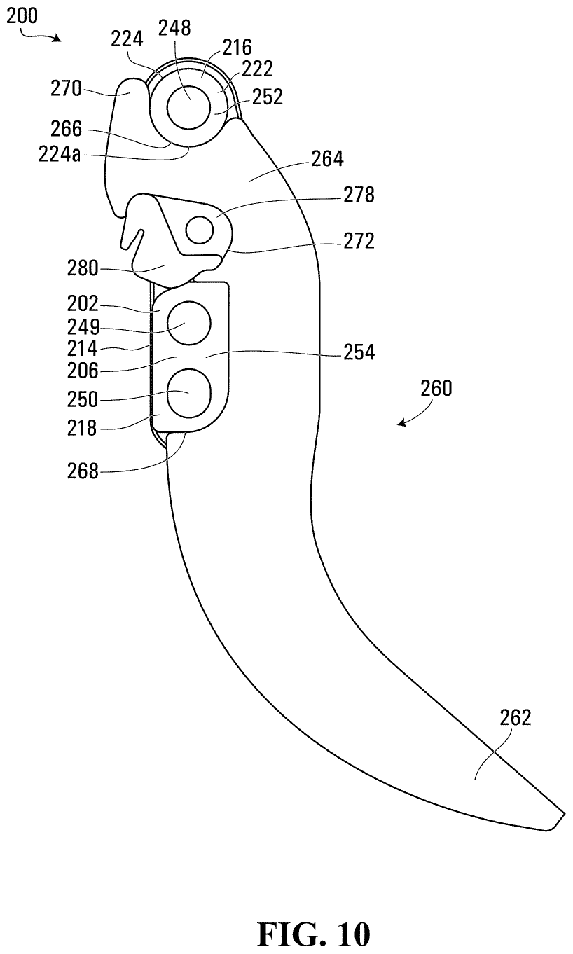

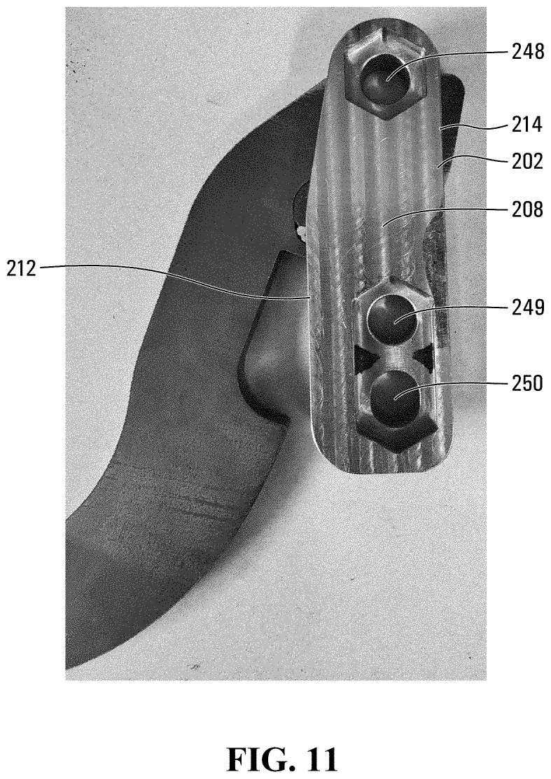

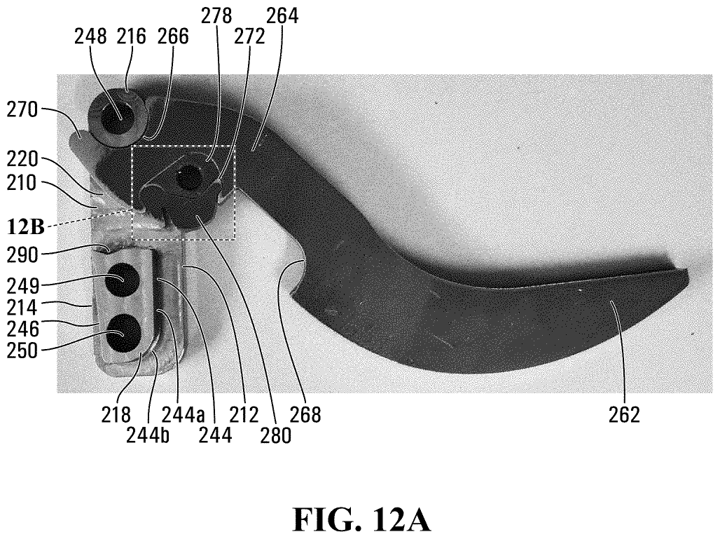

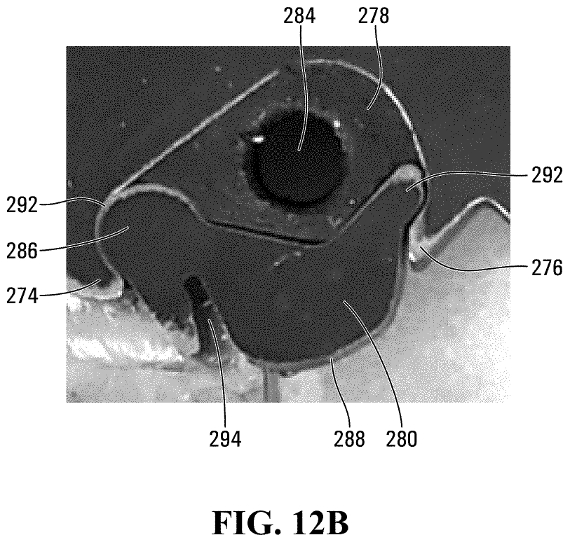

Yet other embodiments are possible. Referring to FIGS. 10 to 16 a further embodiment of a system for connecting tines to a rotor of a tilling machine will be described.

The system 200 includes an adaptor 202 comprising a body 206 having a generally flat top side 208, a generally flat underside 210, a flat front side 212 and a generally flat rear side 114. First and second adaptor coupling portions 216 and 218, respectively, project from the under side 210 at opposite ends of the body 206, respectively, defining a gap or aperture 220 therebetween.

The first coupling portion 216 includes a first stop portion 222 positioned or arranged adjacent the rear side 214. In this embodiment, the first stop portion 222 has a generally cylindrical outer stop surface 224.

The second coupling portion 218 is positioned or arranged opposite the first coupling portion 216 at a bottom of the adaptor 202. The second coupling portion 218 includes a second stop portion 242. The second stop portion 242 defines a second stop surface 244 having a generally straight surface portion 244a facing away from the rear side 214 that merges with a curved lower stop surface portions 244b, which faces away from the aperture 220. Moreover, the second coupling portion 218 defines a rear surface 246.

The first and second coupling portions 216, 218 define through bores 248, 249 and 250, which are intended to line up with holes on various configurations of the rotor 12, permitting the adaptor 202 to be mounted to the rotor 12, for example using bolts. Moreover the first and second coupling portions 216, 218, comprise generally flat, co-planar under sides 252, 254, respectively, that are parallel to the under side 210 and contact the rotor 12 when the adaptor 202 is mounted thereto. Once mounted, the rotor thus forms a second wall to the aperture 220 opposite the underside 210. As in the case of the embodiment illustrated in FIGS. 1 to 8, the height of the first and second coupling portions 216, 218 with respect to the underside 210 therefore also define a thickness T of the aperture 220 when the adaptor 202 is mounted to the rotor 12.

A tine 260 for use with the adaptor 202 as part of the system 200 is shown. In the illustrated embodiment, the tine 260 includes a working part 262, forming one end of the tine 260 opposite a coupling part 264. The coupling part 264 includes first and second tine coupling portions, respectively.

In the illustrated embodiment, the first and second tine coupling portions are configured as recesses 266 and 268, which are shaped complementary to and receive at least part of the first and second stop surfaces 224, 244, respectively. In particular, the coupling part 264 includes an arm-like extension 270 that, when the tine 260 is in a coupling position within the adaptor 202, extends rearwards past the rear side 214 and at least part of the way around or along the first stop portion 222, contacting the stop surface portion 224a.

The coupling part 264 further includes a recessed portion 272, which is defined between lips 274 and 276. Recessed portion 272 is configured to receive biasing member 278 and locking element 280, configured as a lever in the illustrated embodiment.

In the illustrated embodiment, the biasing member 278 is configured as a resilient, compressible member shaped to occupy a remainder of the space between the locking element 280 and the coupling part 264 when the locking element 280 is placed into its appropriate position within the recessed portion 272. The biasing member 278 includes a hole or opening 282, which aids in permitting the biasing member 278 to be resiliently compressed. For example, the biasing member 278 may be formed of a rubber insert. A suitable durometer may be chosen depend on the desired resiliency. The locking element 280 includes a retaining lip 284 at one end and a rounded pivot portion 286 at an opposing end. A locking portion 288 is positioned facing away from the biasing member 278. The locking portion 288 is shaped, positioned, sized and/or configured to mate with a locking surface 290 on the second coupling portion 218. The retaining lip 284 is positioned between lip 276 and the biasing member 278 and aids to retain the locking element 280 in place. The biasing member 278 exerts a force onto the retaining lip 284, pressing it towards the lip 276. The pivot portion 286 is rounded and shaped to fit within a mating, rounded pivot surface 292 of the recessed portion 272 and adjacent the lip 274, which also aids to retain the locking element 280 in place. The biasing member 278 exerts a force onto the pivot portion 286, pressing it towards the lip 274. Thus, more generally, the locking element 280 is sized and shaped to be held within the recessed portion 272 and pivotable towards the coupling part 264.

Other embodiments are possible. For example, other means of pivoting the locking element may be known to those skilled in the art, including a pivot pin, spring-loaded lever, hinge, etc.

In the illustrated embodiment, the locking element 280 further includes a slot 294 that may be used for pivoting and releasing the locking element 280, as further described below.

For assembly, the locking element 280 may be placed first in the recessed portion 272, followed by the biasing member 278 which is inserted, e.g. by hand. Accordingly, no additional tools may be needed to assembly the biasing member 278, locking element 280 and tine 260.

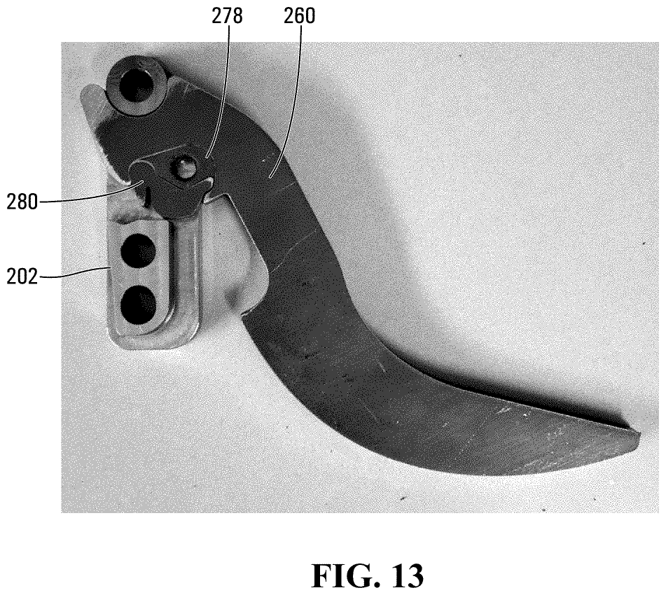

To mount the tine 260 to the rotor 12 after the adaptor 202 is mounted to the rotor 12, as described above, the tine 260 is inserted into the aperture 220 from the front until the extension 270 clears the rear side 214 and the first stop portion 240 (FIG. 13). The tine 260 is then rotated into the coupling position such that the first and second recesses 266, 268 receive and contact the first and second stop portions 222, 242, respectively.

In doing so, the locking portion 288 of the locking element 280 contacts the second coupling portion 218, causing the pivot portion 286 to pivot or rotate within the pivot surface 292, the thereby compressing the resilient biasing member 278. As the tine 260 is further rotated, the rounded locking portion 288 engages and mates with the locking surface 290, being urged and biased into contact with the locking surface 290 by the biasing member 278. The locking element 280, adaptor 202, and tine 260 are sized and configured so that in the coupling position, the locking element 280 engages the second coupling portion 218 and the second stop portion 242 is received within the second recess 268.

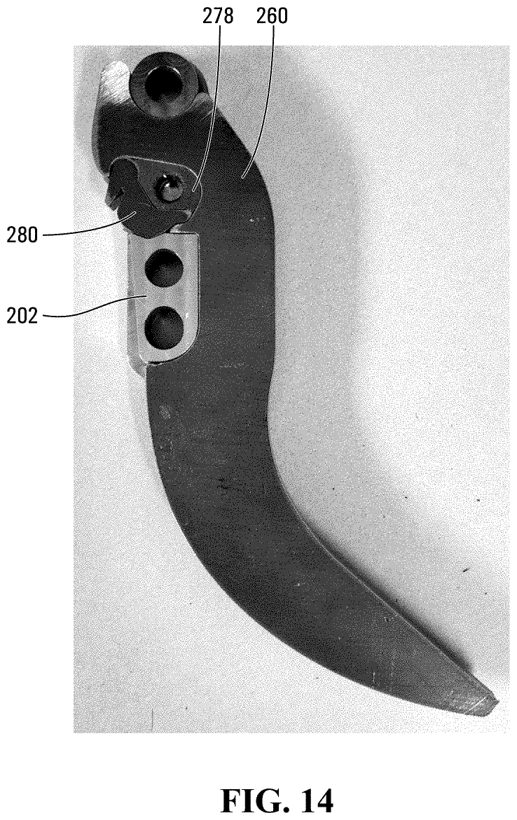

In the coupling position, the locking element 280 resists removal of the tine 260 rearward or frontward due to interference with the adaptor 202 (FIG. 14). Moreover, the thickness of the tine 260 generally matches that of the aperture 220 such that the tine 260 is held relatively firmly in place between the rotor 12 on the one side and the underside 210 on the other side.

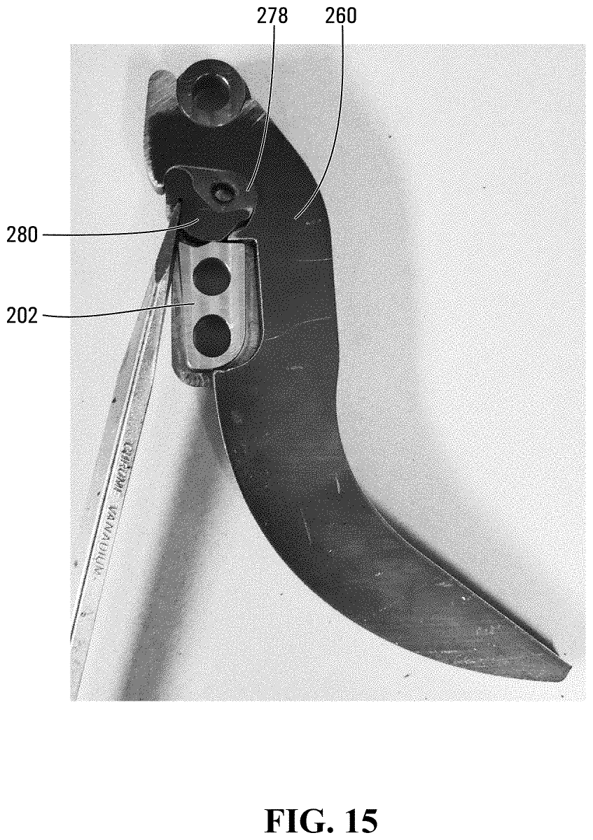

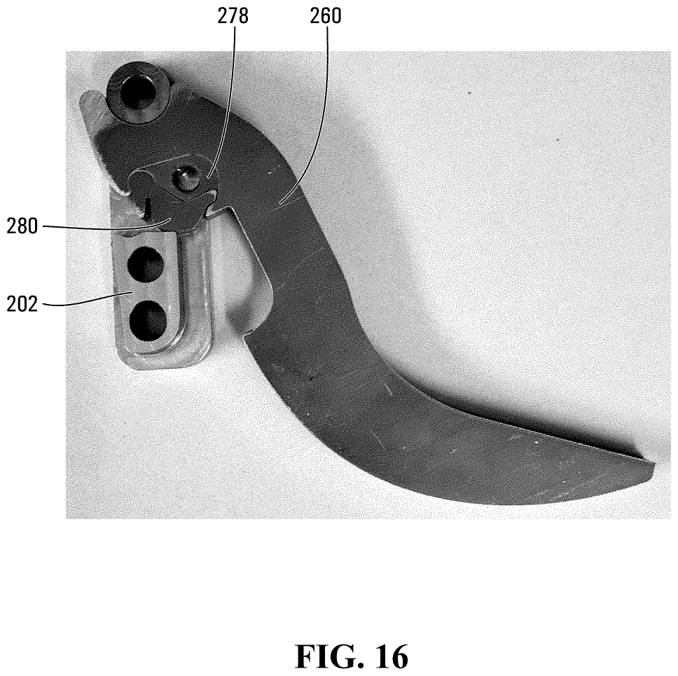

To release the tine 260, a tool, such as a flat head screw driver, may be inserted into the slot 294 (FIG. 15) to pivot the locking element 280 in a manner that compress the biasing member 278, thereby disengaging the locking element 280 from the locking surface 290 and adapter 202. The tine 260 may then be rotated back out (FIG. 16). In such a manner, a tine 260 may be quickly and easily connected and disconnected from the rotor, as compared to the prior art method of connecting the tine directly using bolts.

As in the embodiments described in respect of FIGS. 1-8, the working part 262 is angled away from the adaptor 202 such that, when in use, forces on the working part 262 generate a moment that urge the coupling part 264 into engagement with the adaptor 202.

Other embodiments are possible. For example, in some embodiments, the biasing member may be configured as a spring, such as a coil or leaf spring. The locking element may be integral with or separate from the biasing member. The shape, size, and configuration of the recessed portion, biasing member and locking element may differ from the embodiment illustrated. Consequently, the adaptor may be configured differently than illustrated to receive and/or engage with the locking element.

In yet other embodiments, the locking element and/or biasing member may be coupled or connected to the adaptor. In such a configuration, the locking element would engage with a corresponding feature on the coupling part of the tine.

Accordingly, embodiments of the method for mounting a tine to a rotor as described in respect of FIG. 9, also apply to the embodiment of FIGS. 10 to 16. An adaptor, such as the adaptor 202, is mounted to the rotor, defining an aperture between the adaptor and the rotor. The tine, such as the tine 260, is positioned in the aperture in a coupling position the tine mates with the adaptor. In doing so, the locking element is moved into the locking position in which it resists the tine from being extracted from the coupling position.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, terms such as “top”, “bottom”, “front”, “rear”, “downwards”, “upwards” and other directional terms are intended to aid in discussion of the relative features of embodiments of the disclosure, but are not limiting. It will be understood that these terms may be reversed or switched without altering the scope of the disclosure.

As used herein, the terms “comprises,” “comprising,” “includes,” “including,” “has,” “having” or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms “approximately,” “about,” “substantially” and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Moreover, it will be understood that features of one embodiment may be combined with features of other embodiments, even if not expressly recited or described as a combination.

1. A system for connecting tines to a rotor of a tilling machine, the system comprising:
an adaptor for mounting to the rotor, the adaptor comprising first and second adaptor coupling portions defining an aperture therebetween;
a tine for coupling to the adaptor by insertion into the aperture, the tine comprising first and second tine coupling portions shaped complementary to the first and second adaptor coupling portions, respectively, the tine being positionable in the aperture in a coupling position, the first and second tine coupling portions mating with the first and second adaptor coupling portions, respectively, in the coupling position; and
a locking element movably coupled to one of the adaptor and the tine, the locking element movable into a locking position to engage the other of the adaptor and the tine when in the coupling position to resist removal of the tine from the coupling position.

2. The system of claim 1, wherein, in the locking position, the locking element exerts a force on the tine to urge the tine against the first and second adaptor coupling portions.

3. The system of claim 1, wherein the locking element is configured as a set screw that is advanced through a bore in the adaptor.

4. The system of claim 1, wherein the rotor has an axis of rotation and wherein the locking element is movable unidirectionally along an axis of movement non-parallel to the axis of rotation.

5. The system of claim 4, wherein the axis of movement lies on a plane orthogonal to the axis of rotation.

6. The system of claim 1, wherein the adaptor further comprises a body with a substantially flat side extending between the first and second adaptor coupling portions and defining a wall of the aperture.

7. The system of claim 6, wherein the side is substantially parallel to a surface of the rotor when the adaptor is mounted thereto.

8. The system of claim 1, wherein the first and second adaptor coupling portions comprise coplanar surfaces that contact the rotor when the adaptor is mounted to the rotor.

9. The system of claim 1, wherein the tine has a coupling end comprising the first and second tine coupling portions and a working end, the working end extending from the coupling end such that, in use, forces exerted on the working end urge the tine against the first and second adaptor coupling portions.

10. The system of claim 1, wherein the first and second adaptor coupling portions are configured as shaped projections projecting from the adaptor and the first and second tine coupling portions are configured as complementary recesses that receive the projections.

11. The system of claim 1, wherein the first and second adaptor coupling portions are positioned on opposite sides of the tine in the coupling position.

12. The system of claim 1, wherein locking element is coupled to the tine and engages a locking surface on the adaptor.

13. The system of claim 1, wherein the locking element is pivotably coupled to the tine.

14. The system of claim 1, wherein the locking element is configured as a lever.

15. The system of claim 1, further comprising a biasing member to bias the locking element in the locking position.

16. The system of claim 15, wherein the biasing member is made of a resilient material.

17. The system of claim 15, wherein the locking element is releasable out of the locking position by compressing the biasing member.
The system of claim 15, wherein the locking element and biasing member are held in placed in a recessed portion of the tine, the biasing member biasing the locking element against the tine.

18. A method of connecting a tine to a rotor of a tilling machine, the method comprising:
mounting an adaptor to the rotor, the adaptor defining an aperture between the adaptor and the rotor;
positioning the tine in the aperture in a coupling position in which the tine mates with the adaptor; and
moving a locking element into a locking position in which it resists the tine from being extracted from the coupling position.

19. The method of claim 18, wherein mounting the adaptor to the rotor comprises connecting the adaptor to the rotor at two connection points spaced from each other.

20. The method of claim 18, wherein the rotor has an axis of rotation and a face perpendicular to the axis of rotation, and positioning the tine comprises positioning the tine such that the tine is substantially parallel to the face when in the coupling position.

21. The method of claim 18, wherein positioning the tine in the coupling position comprises inserting the tine in the aperture until the tine clears at least one adaptor coupling portion and rotating the tine into the coupling position to mate with the at least one adaptor coupling portion.

22. The method of claim 21, wherein rotating the tine into the coupling position comprises rotating the tine into the coupling position to mate with first and second adaptor coupling portions spaced from each other.

23. The method of claim 18, wherein moving the locking element to engage the tine comprises applying a force on the tine to urge the tine further into the coupling position.

24. The method of claim 18, wherein the locking element is a set bolt and moving the locking element comprises advancing the set bolt.

25. The method of claim 18, wherein the locking element comprises a lever and moving the locking element comprises urging the lever to compress a biasing member.

26. The method of claim 18, further comprising release the locking element to extract the tine.

27. The method of claim 26, wherein releasing the locking element comprises retracting the locking element from a locking position.

28. The method of claim 26, wherein releasing the locking element comprises pivoting the locking element out of a locking position.

29. The method of claim 18, wherein moving the locking element into the locking position comprises deforming a biasing member biasing the locking element towards the locking position.

30. A tine for connecting to a rotor of a tilling machine, the tine comprising:
a coupling part, the coupling part having first and second tine coupling portions spaced from each other, each of first and second tine coupling portions comprising a recess shaped to receive a complementary portion of an adaptor mounted to the tine; and
a working part extending from the coupling part.

31. The tine of claim 30, wherein the first and second tine coupling portions each comprise at least one respective recess for receiving complementary portions of the adaptor.

32. The tine of claim 30, wherein the first tine coupling portion has a recess with an at least partially curved surface.

33. The tine of claim 30, further comprising a locking surface for engaging with a locking element.

34. The tine of claim 30, further comprising a recessed portion configured to receive a locking element.

35. The tine of claim 34, wherein the recessed portion is further configured to receive a biasing member.

36. The tine of claim 30, wherein the recessed portion comprises first and second lips defining an opening to the recessed portion, the first and second lips configured to aid in retaining a locking element.

37. The tine of claim 30, wherein the working part has a tip that extends away from the space between the first and second tine coupling portions. 38. The tine of claim 30, wherein the recess of the second tine coupling portion is formed in a back side of the tine, and the tine comprises a portion that extends past the back side between the first and second tine coupling portions.

39. In combination: a tine according to claim 30, a locking element and a resilient biasing member, the tine having a recessed portion for receiving and retaining the locking element and the biasing member.

40. The combination of claim 39, wherein the biasing member urges the locking element against the tine.

41. The combination of claim 39, wherein the locking element is retained by first and second lips that define an opening of the recessed portion.

42. The combination of claim 39, wherein the locking element comprises a pivot portion about which the locking element is pivotable.

43. The combination of claim 42, wherein the pivot portion is rounded and is pivotable within a complementarily shaped pivot surface of the tine.
